(19) United States
(12) Patent Application Publication
(10) Pub. No.: US 2021/0163795 A1
(43) Pub. Date: Jun. 3, 2021

(54) PRESSURE-SENSITIVE ADHESIVE SHEET

(71) Applicant: NITTO DENKO CORPORATION, Osaka (JP)

(72) Inventors: Toshiki IKAMI, Osaka (JP); Shigeki WATANABE, Osaka (JP); Yasushi BUZOJIMA, Osaka (JP); Naohiro KATO, Osaka (JP)

(73) Assignee: NITTO DENKO CORPORATION, Osaka (JP)

(21) Appl. No.: 17/095,960

(22) Filed: Nov. 12, 2020

(30) Foreign Application Priority Data
Nov. 29, 2019 (JP) 2019-217216

(51) Int. Cl. C09J 9/00; C09J 7/28; C09J 7/38; C09J 11/06

(52) U.S. Cl. CPC C09J 9/00; C09J 7/28; C09J 7/385; C09J 2301/408; C09J 2203/326; C09J 2301/302; C09J 2301/314; C09J 11/06

(57) ABSTRACT

A pressure-sensitive adhesive sheet includes a substrate layer, and a pressure-sensitive adhesive layer disposed on or over at least one side of the substrate layer. The substrate layer includes a metal layer having a thickness of 10 to 80 μm. The pressure-sensitive adhesive sheet has a total thickness of 100 μm or less, and has an electric field shielding effect of 20 dB or more and a magnetic field shielding effect of 5 dB or more as measured by the KEC method at a frequency of 100 kHz to 1000 kHz. The pressure-sensitive adhesive sheet is used for securing an internal component of a portable electronic device.

### TECHNICAL FIELD

The present invention generally relates to pressure-sensitive adhesive sheets. More specifically, the present invention relates to a pressure-sensitive adhesive sheet for use in securing of an internal component of a portable electronic device.

### BACKGROUND ART

With an increasing degree of integration of electronic substrate components to constitute an electronic device, an element such as a central processing unit (CPU) or a connector may be arranged in proximity to an antenna section. In such a case, electromagnetic waves emitted from the element such as CPU or connector will cause malfunction of the device. To eliminate or minimize such malfunction, there takes measures. For example, the element such as CPU or connector is covered with an electromagnetic shielding material.

A non-limiting example of the electromagnetic shielding material is a conductive pressure-sensitive adhesive tape including a conductive pressure-sensitive adhesive layer lying on a metal foil such as copper foil or aluminum foil. PCT International Publication Number WO2015/076174 (PTL 1) discloses a conductive pressure-sensitive adhesive sheet that has a total thickness of 30 μm or less and includes a conductive substrate and a conductive pressure-sensitive adhesive layer containing conductive particles. This literature teaches that the conductive pressure-sensitive adhesive sheet, even though having a very low profile, has good adhesiveness to an adherend and good conductivity.

### CITATION LIST

### Patent Literature

PTL 1: PCT International Publication Number WO2015/076174

### SUMMARY OF INVENTION

### Technical Problem

Portable electronic devices such as smartphones have also been miniaturized with an increasing degree of integration. This needs restrainment of electromagnetic waves from permeating into the devices. In addition, some portable electronic devices need restrainment of low-frequency electromagnetic waves from such permeation. However, the conductive pressure-sensitive adhesive tape disclosed in PTL 1 has insufficient shielding performance against low-frequency electromagnetic waves.

The present invention has been made under these circumstances and has an object to provide a pressure-sensitive adhesive sheet that is used for securing an internal component of a portable electronic device and has excellent shielding performance against electromagnetic waves in a low-frequency region.

### Solution to Problem

After intensive investigations to achieve the object, the inventors of the present invention found that a specific pressure-sensitive adhesive sheet, when used for securing an internal component of a portable electronic device, has excellent shielding performance against electromagnetic waves in a low-frequency region. This pressure-sensitive adhesive sheet includes a substrate layer, and a pressure-sensitive adhesive layer disposed on or over at least one side of the substrate layer. The substrate layer includes a metal layer having a thickness of 10 to 80 μm. The pressure-sensitive adhesive sheet has a total thickness of 100 μm or less. The pressure-sensitive adhesive sheet has an electric field shielding effect of 20 dB or more and a magnetic field shielding effect of 5 dB or more in a low-frequency region. The present invention has been made on the basis of these findings.

The present invention provides, according to one embodiment, a pressure-sensitive adhesive sheet including a substrate layer and a pressure-sensitive adhesive layer disposed on or over at least one side of the substrate layer. The substrate layer includes a metal layer having a thickness of 10 to 80 μm. The pressure-sensitive adhesive sheet has a total thickness of 100 μm or less. The pressure-sensitive adhesive sheet has an electric field shielding effect of 20 dB or more as measured by the KEC method at a frequency of 100 kHz to 1000 kHz. The pressure-sensitive adhesive sheet has a magnetic field shielding effect of 5 dB or more as measured by the KEC method at a frequency of 100 kHz to 1000 kHz. The pressure-sensitive adhesive sheet is used for securing an internal component of a portable electronic device.

The pressure-sensitive adhesive sheet, as having a total thickness of 100 μm or less, is thin in thickness and is suitable for securing an internal component of a portable electronic device. The substrate layer includes a metal layer, the metal layer has a thickness of 10 to 80 μm, and the pressure-sensitive adhesive sheet has an electric field shielding effect of 20 dB or more and a magnetic field shielding effect of 5 dB or more as measured by the KEC method at a frequency of 100 kHz to 1000 kHz. This configuration restrains electromagnetic waves in a low-frequency region from permeating into the portable electronic device.

The pressure-sensitive adhesive layer preferably includes an acrylic polymer as a base polymer, and a tackifier resin. The pressure-sensitive adhesive sheet has a total thickness of 100 μm or less, and the metal layer in the substrate layer has a thickness of 10 to 80 μm. This causes the pressure-sensitive adhesive layer in the pressure-sensitive adhesive sheet to inevitably have a small thickness. In particular, when the pressure-sensitive adhesive sheet is a double-sided pressure-sensitive adhesive sheet, each pressure-sensitive adhesive layer has a still smaller thickness. However, as the pressure-sensitive adhesive layer includes an acrylic polymer as a base polymer, and a tackifier resin, the pressure-sensitive adhesive sheet has excellent adhesion to the internal component of the portable electronic device and resists separation from the internal component.

The acrylic polymer preferably includes at least one of a constitutional unit derived from a carboxy-containing monomer and a constitutional unit derived from an acid anhydride monomer. This allows the pressure-sensitive adhesive layer to excellently adhere to the internal component of the portable electronic device.

The pressure-sensitive adhesive layer preferably includes an azole rust inhibitor, in a proportion of 8 parts by mass per 100 parts by mass of the totality of the base polymer. When the pressure-sensitive adhesive layer includes an azole rust inhibitor in a proportion within the range, the pressure-sensitive adhesive sheet can exhibit higher cohesive force (such as thermostable cohesive force) and to provide still better adhesion to the internal component of the portable electronic device, while restraining corrosion of the metal layer and a metal to be used as or in the internal part (internal component) of the portable electronic device. The azole rust inhibitor preferably includes at least one benzotriazole compound selected from the group consisting of 1,2,3-benzotriazole, 5-methylbenzotriazole, 4-methylbenzotriazole, and carboxybenzotriazole.

The pressure-sensitive adhesive sheet preferably has a thickness ratio of the pressure-sensitive adhesive layer to the substrate layer of from 0.05 to 1.0. While having a total thickness of 100 μm or less, the pressure-sensitive adhesive sheet, when having a thickness ratio as above of 0.05 or more, allows the pressure-sensitive adhesive layer to exhibit its adhesive strength more sufficiently and to have still better adhesion to the internal component of the portable electronic device. The pressure-sensitive adhesive sheet, when having a thickness ratio as above of 1.0 or less, allows the metal layer in the substrate layer to have a relatively large thickness and to provide still better shielding performance against electromagnetic waves in a low-frequency region.

The pressure-sensitive adhesive layer is preferably used to be applied to a metallic part (metallic internal part) inside the portable electronic device.

### Advantageous Effects of Invention

The pressure-sensitive adhesive sheet according to the embodiment of the present invention, when used for securing an internal component of a portable electronic device, has excellent shielding performance against electromagnetic waves in a low-frequency region.

### BRIEF DESCRIPTION OF DRAWINGS

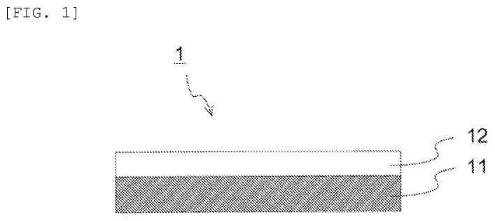

The single FIGURE (FIG. 1) is a schematic view (vertical cross-sectional view) of a pressure-sensitive adhesive sheet according to one embodiment of the present invention.

### DESCRIPTION OF EMBODIMENTS

A pressure-sensitive adhesive sheet according to one embodiment of the present invention includes a substrate layer, and a pressure-sensitive adhesive layer disposed on or over at least one side of the substrate layer. The pressure-sensitive adhesive sheet may be a single-sided pressure-sensitive adhesive sheet having the pressure-sensitive adhesive layer on one side of the substrate layer; or may be a double-sided pressure-sensitive adhesive sheet having the pressure-sensitive adhesive layer on both sides of the substrate layer. The substrate layer includes a metal layer.

FIG. 1 is a schematic cross-sectional view of a pressure-sensitive adhesive sheet according to one embodiment of the present invention. As illustrated in FIG. 1, the pressure-sensitive adhesive sheet 1 includes a substrate layer 11, and a pressure-sensitive adhesive layer 12 disposed on or over at least one side of the substrate layer 11. The substrate layer 11 is, for example, a metal layer.

Non-limiting examples of the metal layer include metal foil such as rolled metal foil and electrolytic metal foil; metal-deposited films; and metal plating films. The metal layer may be a single layer, or include multiple layers. The metal layer may be made of or made from one metal, or two or more different metals.

The metal to constitute the metal layer is preferably one having a resistivity of 4.0×10⁻⁸ Ω·m or less, and more preferably one having a resistivity of 3.0×10⁻⁸ Ω·m or less. The metal layer, when made of such a metal having a resistivity of 4.0×10⁻⁸ Ω·m or less, tends to have better shielding performance against electromagnetic waves in a low-frequency region, even though having a small thickness of 10 to 80 μm.

The metal to constitute the metal layer is preferably one having an electric conductivity of 40% or more, and more preferably one having an electric conductivity of 55% or more. The metal layer, when made of such a metal having an electric conductivity of 40% or more, tends to have still better shielding performance against electromagnetic waves in a low-frequency region, even though having a small thickness of 10 to 80 μm.

The metal to constitute the metal layer is preferably one having a permeability of 1 or more, more preferably one having a permeability of 200 or more, still more preferably one having a permeability of 230 or more, and particularly preferably one having a permeability of 280 or more, provided that copper has a permeability of 1. The metal layer, when made of such a metal having a permeability of 1 or more, tends to have still better shielding performance against electromagnetic waves in a low-frequency region, even though having a small thickness of 10 to 80 μm.

In particular, the metal to constitute the metal layer is preferably one having an electric conductivity within the range and/or having a permeability within the range.

The metal to constitute the metal layer is preferably selected from gold, silver, copper, aluminum, and iron; and alloys including at least one of these metals. The metal layer made of such a metal as above tends to have still better shielding performance against electromagnetic waves in a low-frequency region even though having a small thickness of 10 to 80 μm. The metal layer is preferably a copper layer, silver layer, aluminum layer, or iron layer for providing still better shielding performance against electromagnetic waves in a low-frequency region; and is preferably a copper layer from the viewpoint of economic efficiency.

The metal layer has a thickness of 10 to 80 μm, and preferably has a thickness of 10 to 60 μm. In particular, the metal layer, when being a copper layer or silver layer, preferably has a thickness of 30 to 60 μm. The metal layer, when being an aluminum layer, preferably has a thickness of 10 to 30 μm. The metal layer, when being an iron layer, preferably has a thickness of 40 to 70 μm.

The substrate layer may further include any other substrate than the metal layer. Non-limiting examples of the other substrate include plastic films, antireflection (AR) films, polarizing plates, retardation films, and other optical films. Non-limiting examples of the other substrate also include porous materials such as paper, fabrics, and nonwoven fabrics; nets; and foamed sheets. Non-limiting examples of materials to constitute the plastic films and other films include plastic materials exemplified by polyester resins such as poly(ethylene terephthalate)s (PETs); acrylic resins such as poly(methyl methacrylate)s (PMMAs); polycarbonates; triacetyl cellulose (TAC); polysulfones; polyarylates; polyimides; poly(vinyl chloride)s; poly(vinyl acetate)s; polyethylenes; polypropylenes; ethylene-propylene copolymers; and cycloolefin polymers such as trade name ARTON (a cycloolefin polymer, supplied by JSR Corporation) and trade name ZEONOR (a cycloolefin polymer, supplied by ZEON CORPORATION). The other substrate may be made of or from each of different plastic materials alone or in combination. As used herein, the term “the other substrate” does not include a separator (release liner), which is removed upon use (application) of the pressure-sensitive adhesive sheet.

The surface of the substrate layer which faces the pressure-sensitive adhesive layer may have undergone a surface treatment to increase properties such as adhesion to and retainability by the pressure-sensitive adhesive layer. Non-limiting examples of the surface treatment include physical treatments such as corona discharge treatment, plasma treatment, sand mat treatment, ozone exposure treatment, flame exposure treatment, high-voltage electric shock exposure treatment, and ionizing radiation treatment; chemical treatments such as chromate treatment; and adhesion facilitating treatments with a coating agent (primer). Preferably, the entire surface of the substrate layer which faces the pressure-sensitive adhesive layer has undergone such a surface treatment to increase the adhesion.

The pressure-sensitive adhesive to form the pressure-sensitive adhesive layer is not limited, but examples thereof include acrylic pressure-sensitive adhesives, rubber pressure-sensitive adhesives (such as natural rubber ones, synthetic rubber ones, and mixtures of them), silicone pressure-sensitive adhesives, polyester pressure-sensitive adhesives, urethane pressure-sensitive adhesives, polyether pressure-sensitive adhesives, polyamide pressure-sensitive adhesives, and fluorine (fluorocarbon) pressure-sensitive adhesives. Among them, the pressure-sensitive adhesive to form the pressure-sensitive adhesive layer is preferably selected from acrylic pressure-sensitive adhesives, from the viewpoints of transparency, adhesion, weatherability, cost, and easy designing of the pressure-sensitive adhesive. The pressure-sensitive adhesive layer is preferably an acrylic pressure-sensitive adhesive layer made from an acrylic pressure-sensitive adhesive. The pressure-sensitive adhesive layer may include (be made from) each of different pressure-sensitive adhesives alone or in combination.

The acrylic pressure-sensitive adhesive layer contains an acrylic polymer as a base polymer. The acrylic polymer is a polymer that is derived from a monomer component or components including an acrylic monomer (monomer having a (meth)acryloyl group in the molecule). Namely, the acrylic polymer includes a constitutional unit derived from such an acrylic monomer. The acrylic polymer is preferably a polymer derived from monomer component(s) including a (meth)acrylic alkyl ester. The acrylic pressure-sensitive adhesive layer may contain each of different acrylic polymers alone or in combination.

As used herein, the term “base polymer” refers to a principal component among polymer components to form the pressure-sensitive adhesive layer, such as a polymer component present in a content greater than 50 mass percent. The acrylic pressure-sensitive adhesive layer contains the acrylic polymer in a content of preferably 70 mass percent or more, more preferably 90 mass percent or more, and still more preferably greater than 98 mass percent, of the totality (100 mass percent) of the acrylic pressure-sensitive adhesive layer. The acrylic pressure-sensitive adhesive layer may be a pressure-sensitive adhesive layer whose polymer component is composed of an acrylic polymer or polymers approximately alone.

The acrylic polymer is preferably a polymer that is derived from monomer components essentially including a (meth)acrylic alkyl ester. Namely, the acrylic polymer preferably includes a constitutional unit derived from a (meth)acrylic alkyl ester. As used herein, the term “(meth)acryl(ic)” refers to “acryl(ic)” and/or “methacryl(ic)” (“acryl(ic)”, or “methacryl(ic)”, or both). The same is true for other expressions.

The (meth)acrylic alkyl ester as an essential monomer component is preferably selected from (meth)acrylic alkyl esters having linear or branched-chain alkyl. The monomer component(s) to form the acrylic polymer may include each of different (meth)acrylic alkyl esters alone or in combination.

Non-limiting examples of the (meth)acrylic alkyl ester having linear or branched-chain alkyl include (meth)acrylic alkyl esters having C₁-C₂₀ linear or branched-chain alkyl, such as methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate (stearyl (meth)acrylate), isostearyl (meth)acrylate, nonadecyl (meth)acrylate, and icosyl (meth)acrylate. Among the (meth)acrylic alkyl esters having linear or branched-chain alkyl, preferred are (meth)acrylic alkyl esters having C₁-C₁₈ (in particular, C₂-C₄) linear or branched-chain alkyl, and more preferred is butyl (meth)acrylate (BA) from the viewpoint of capability of forming a pressure-sensitive adhesive layer that provides good adhesion even though having a small thickness.

The proportion of the (meth)acrylic alkyl ester(s) in the monomer components to form the acrylic polymer is not limited, but is preferably 50 mass percent or more (e.g., 50 to 100 mass percent), more preferably 70 mass percent or more, still more preferably 85 mass percent or more, and particularly preferably 90 mass percent or more, of the totality (100 mass percent) of all the monomer components. The proportion is preferably less than 100 mass percent, more preferably 99.5 mass percent or less, still more preferably 98 mass percent or less, and particularly preferably 97 mass percent or less. The (meth)acrylic alkyl ester(s), when present in a proportion within the range, has a good quantitative balance with a copolymerizable monomer and allows the formed pressure-sensitive adhesive layer to have good adhesion even though having a small thickness.

The acrylic polymer may be derived from monomer components including a copolymerizable monomer in combination with the (meth)acrylic alkyl ester(s). Namely, the acrylic polymer may include a constitutional unit derived from such a copolymerizable monomer. The monomer components may include each of different copolymerizable monomers alone or in combination.

The copolymerizable monomer is preferably at least one of a carboxy-containing monomer and an acid anhydride monomer, from the viewpoint of allowing the formed pressure-sensitive adhesive layer to provide good adhesion even though having a small thickness. Non-limiting examples of the carboxy-containing monomer include acrylic acid, methacrylic acid, carboxyethyl (meth)acrylate, carboxypentyl (meth)acrylate, itaconic acid, maleic acid, fumaric acid, and crotonic acid. Non-limiting examples of the acid anhydride monomer include maleic anhydride and itaconic anhydride.

The proportion of at least one of the carboxy-containing monomer and the acid anhydride monomer in the monomer components to form the acrylic polymer is not limited, but is preferably 0.2 mass percent or more, more preferably 0.5 mass percent or more, still more preferably 1 mass percent or more, and particularly preferably 2 mass percent or more, and may be 3 mass percent or more, 3.2 mass percent or more, 3.5 mass percent or more, 4 mass percent or more, or 4.5 mass percent or more, of the totality (100 mass percent) of all the monomer components. The proportion is preferably 15 mass percent or less, more preferably 12 mass percent or less, still more preferably 10 mass percent or less, and particularly preferably 7 mass percent or less, and may be less than 7 mass percent, 6.8 mass percent or less, or 6 mass percent or less. The at least one of a carboxy-containing monomer and an acid anhydride monomer, when present in the monomer components in a proportion within the range, has a good quantitative balance with the (meth)acrylic alkyl ester(s) and allows the formed pressure-sensitive adhesive layer to have good adhesion even though having a small thickness.

The monomer components may further include, as the copolymerizable monomer, a functionality-containing monomer, to introduce crosslinking points into the acrylic polymer, and/or to increase the cohesive force of the acrylic polymer. Non-limiting examples of the functionality-containing monomer include hydroxy-containing monomers, epoxy-containing monomers, nitrogen-containing monomers, keto-containing monomers, alkoxysilyl-containing monomers, sulfonate-containing monomers, and phosphate-containing monomers.

Non-limiting examples of the hydroxy-containing monomers include hydroxyalkyl (meth)acrylates such as 2-hydroxyethyl (meth)acrylate, 2-hydroxypropyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)methyl (meth)acrylate; unsaturated alcohols such as vinyl alcohol and allyl alcohol; and polypropylene glycol mono(meth)acrylates.

Non-limiting examples of the epoxy-containing monomers include glycidyl-containing monomers such as glycidyl (meth)acrylate, methylglycidyl (meth)acrylate, and allyl glycidyl ether.

Non-limiting examples of the nitrogen-containing monomers include amido-containing monomers, amino-containing monomers, cyano-containing monomers, and monomers having a nitrogen-containing ring. Non-limiting examples of the amido-containing monomers include (meth)acrylamide, N,N-dimethyl(meth)acrylamide, N-butyl(meth)acrylamide, N-methylol(meth)acrylamide, N-methylolpropane(meth)acrylamide, N-methoxymethyl(meth)acrylamide, and N-butoxymethyl(meth)acrylamide. Non-limiting examples of the amino-containing monomers include aminoethyl (meth)acrylate, N,N-dimethylaminoethyl (meth)acrylate, and t-butylaminoethyl (meth)acrylate. Non-limiting examples of the cyano-containing monomers include acrylonitrile and methacrylonitrile. Non-limiting examples of the monomers having a nitrogen-containing ring include N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam, and N-(meth)acryloylmorpholine.

The keto-containing monomers include diacetone (meth)acrylamide, diacetone (meth)acrylate, vinyl methyl ketone, vinyl ethyl ketone, allyl acetoacetate, and vinyl acetoacetate.

Non-limiting examples of the alkoxysilyl-containing monomers include 3-(meth)acryloxypropyltrimethoxysilane, 3-(meth)acryloxypropyltriethoxysilane, 3-(meth)acryloxypropylmethyldimethoxysilane, and 3-(meth)acryloxypropylmethyldiethoxysilane.

Non-limiting examples of the sulfonate-containing monomers include styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid.

A non-limiting example of the phosphate-containing monomers is 2-hydroxyethylacryloyl phosphate.

The monomer components to form the acrylic polymer may include the functionality-containing monomer or monomers in a proportion of typically 0.1 mass percent or more, 0.5 mass percent or more, or 1 mass percent or more, of the totality (100 mass percent) of all the monomer components. The proportion may be typically 40 mass percent or less, 20 mass percent or less, 10 mass percent or less, or 5 mass percent or less. The monomer components may include approximately no functionality-containing monomer. As used herein, the term “include approximately no . . . ” refers to and includes the case where the component in question is not intentionally incorporated, but is unintentionally present typically by unavoidable incorporation. The proportion in such a case is typically 0.05 mass percent or less, or 0.01 mass percent or less.

The monomer components may further include another monomer as the copolymerizable monomer. Non-limiting examples of the other monomer include vinyl ester monomers such as vinyl acetate, vinyl propionate, and vinyl laurate; aromatic vinyl compounds such as styrene, substituted styrenes (such as α-methylstyrene), and vinyltoluene; cycloalkyl (meth)acrylates such as cyclohexyl (meth)acrylate, cyclopentyl (meth)acrylate, and isobornyl (meth)acrylate; aromatic ring-containing (meth)acrylates such as aryl (meth)acrylates (such as phenyl (meth)acrylate), aryloxyalkyl (meth)acrylates (such as phenoxyethyl (meth)acrylate), and aralkyl (meth)acrylates (such as benzyl (meth)acrylate); olefinic monomers such as ethylene, propylene, isoprene, butadiene, and isobutylene; chlorine-containing monomers such as vinyl chloride and vinylidene chloride; isocyanate-containing monomers such as 2-(meth)acryloyloxyethyl isocyanate; alkoxy-containing monomers such as methoxyethyl (meth)acrylate and ethoxyethyl (meth)acrylate; vinyl ether monomers such as methyl vinyl ether and ethyl vinyl ether.

The proportion of the other monomer in the monomer components to form the acrylic polymer may be typically 0.05 mass percent or more, or 0.5 mass percent or more, of the totality (100 mass percent) of all the monomer components. The proportion may be typically 20 mass percent or less, 10 mass percent or less, or 5 mass percent or less. The monomer components may include approximately no other monomer.

The monomer components to form the acrylic polymer may include a multifunctional monomer which is copolymerizable with another monomer component, to form a bridge structure (crosslinked structure) in the polymer skeleton. Non-limiting examples of the multifunctional monomer include monomers having two or more (meth)acryloyl groups in the molecule, such as hexanediol di(meth)acrylate, (poly)ethylene glycol di(meth)acrylate, (poly) propylene glycol di(meth)acrylate, neopentyl glycol di(meth)acrylate, pentaerythritol di(meth)acrylate, trimethylolpropane tri(meth)acrylate, pentaerythritol tri(meth)acrylate, dipentaerythritol hexa(meth)acrylate; and monomers having a (meth)acryloyl group in combination with another reactive functional group in the molecule, such as epoxy (meth)acrylate (e.g., polyglycidyl (meth)acrylates), polyester (meth)acrylates, and urethane (meth)acrylates. The monomer components may include each of different multifunctional monomers alone or in combination. The multifunctional monomer can function as with the after-mentioned crosslinker and act as the crosslinker.

The acrylic polymer has a glass transition temperature (Tg) of preferably −15° C. or lower, more preferably −25° C. or lower, still more preferably −35° C. or lower, and particularly preferably −40° C. or lower, while the acrylic polymer may have any other glass transition temperature. The glass transition temperature (Tg) is preferably −70° C. or higher, more preferably −65° C. or higher, still more preferably −60° C. or higher, and particularly preferably −55° C. or higher. The acrylic polymer, when having a glass transition temperature (Tg) within the range, tends to allow the formed pressure-sensitive adhesive layer to have good adhesion even though having a small thickness. The glass transition temperature (Tg) is a theoretical value calculated according to the Fox equation.

Herein, the glass transition temperature of a homopolymer for use in the calculation of the glass transition temperature Tg is one taught in known data or documents. For example, the glass transition temperatures, for use herein, of homopolymers derived from the following monomers are as follows:

2-Ethylhexyl acrylate: −70° C.

Isononyl acrylate: −60° C.

n-Butyl acrylate: −55° C.

Ethyl acrylate: −22° C.

Methyl acrylate: 8° C.

Methyl methacrylate: 105° C.

2-Hydroxyethyl acrylate: −15° C.

4-Hydroxybutyl acrylate: −40° C.

Vinyl acetate: 32° C.

Acrylic acid: 106° C.

Methacrylic acid: 228° C.

The glass transition temperatures of homopolymers derived from monomers for use herein other than the above-listed monomers are numerical values listed in “Polymer Handbook” (3rd Ed., John Wiley & Sons, Inc., 1989). For a monomer listed in the literature with two or more different glass transition temperatures, the highest value is employed herein as its glass transition temperature. For a monomer whose homopolymer's glass transition temperature is not listed even in “Polymer Handbook” (3rd Ed., John Wiley & Sons, Inc., 1989), the glass transition temperature for use herein is defined as a value determined by the following measuring method (see Japanese Unexamined Patent Application (JP-A) No. 2007-51271).

Specifically, into a reactor equipped with a thermometer, a stirrer, a nitrogen inlet tube, and a reflux condenser, are charged 100 parts by mass of the monomer to be tested, 0.2 part by mass of azobisisobutyronitrile, and 200 parts by mass of ethyl acetate polymerization solvent, followed by stirring for one hour under a nitrogen gas stream. After removing oxygen from the polymerization system by the above procedure, the temperature is raised to 63° C., followed by reaction for 10 hours. Next, the mixture cools down to room temperature and yields a homopolymer solution having a solids concentration of 33 mass percent. Next, the homopolymer solution is applied to a release liner by flow casting and dried, to give a test sample (sheet homopolymer) having a thickness of about 2 mm. The test sample is blanked (die-cut) into a disc having a diameter of 7.9 mm, placed between parallel plates, and whose viscoelasticity is measured at temperatures of from −70° C. up to 150° C. and a rate of temperature rise of 5° C./min in a shearing mode, using a viscoelasticity tester ARES (trade name, TA Instruments) with a shear strain at a frequency of 1 Hz. On the basis of the measured viscoelasticity, the peak top temperature at tan δ (loss tangent) is defined as the glass transition temperature Tg of the homopolymer.

The acrylic polymer has a weight-average molecular weight of preferably 10×10⁴ to 500×10⁴, more preferably 30×10⁴ to 200×10⁴, still more preferably 45×10⁴ to 150×10⁴, and particularly preferably 65×10⁴ to 130×10⁴. The “weight-average molecular weight” as used herein refers to a value measured by gel permeation chromatography (GPC) and calibrated with a polystyrene standard.

The base polymer such as the acrylic polymer contained in the pressure-sensitive adhesive layer results from polymerization of a monomer component or components. The technique for the polymerization is exemplified by, but not limited to, techniques of solution polymerization, emulsion polymerization, bulk polymerization, and polymerization by actinic radiation irradiation (actinic radiation polymerization). Among them, preferred are solution polymerization and actinic radiation polymerization techniques, and more preferred is solution polymerization technique, from the viewpoint typically of transparency and cost of the pressure-sensitive adhesive layer.

The polymerization of the monomer components may employ one or more of various general solvents. Non-limiting examples of the solvent include organic solvents exemplified by esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methyl ethyl ketone and methyl isobutyl ketone. The polymerization may employ each of different solvents alone or in combination.

The monomer component polymerization may also employ a polymerization initiator such as a thermal initiator or a photo-polymerization initiator (photoinitiator), according to the type of the polymerization reaction. The polymerization may employ each of different polymerization initiators alone or in combination.

Non-limiting examples of the thermal initiator include azo polymerization initiators, peroxide polymerization initiators (such as dibenzoylperoxide, tert-butyl permaleate, potassium persulfate and other persulfates, benzoyl peroxide, and hydrogen peroxide), substituted ethane initiators (such as phenyl-substituted ethane), aromatic carbonyl compounds, and redox polymerization initiators. Among them, the azo polymerization initiators disclosed in JP-A No. 2002-69411 are preferred. Non-limiting examples of the azo polymerization initiators include 2,2′-azobisisobutyronitrile (hereinafter also referred to as “AIBN”), 2,2′-azobis-2-methylbutyronitrile (hereinafter also referred to as “AMBN”), dimethyl 2,2′-azobis(2-methylpropionate), and 4,4′-azobis-4-cyanovaleric acid. The thermal initiator may be used in any common amount, which can be selected within the range of typically 0.005 to 1 part by mass, and preferably 0.01 to 1 part by mass, per 100 parts by mass of the monomer components.

Examples of the photoinitiator include, but are not limited to, benzoin ether photoinitiators, acetophenone photoinitiators, α-ketol photoinitiators, aromatic sulfonyl chloride photoinitiators, photoactive oxime photoinitiators, benzoin photoinitiators, benzil photoinitiators, benzophenone photoinitiators, ketal photoinitiators, and thioxanthone photoinitiators; as well as acylphosphine oxide photoinitiators, and titanocene photoinitiators. Non-limiting examples of the benzoin ether photoinitiators include benzoin methyl ether, benzoin ethyl ether, benzoin propyl ether, benzoin isopropyl ether, benzoin isobutyl ether, 2,2-dimethoxy-1,2-diphenylethan-1-one, and anisole methyl ether. Non-limiting examples of the acetophenone photoinitiators include 2,2-diethoxyacetophenone, 2,2-dimethoxy-2-phenylacetophenone, 1-hydroxycyclohexyl phenyl ketone, 4-phenoxydichloroacetophenone, and 4-(t-butyl)dichloroacetophenone. Non-limiting examples of the α-ketol photoinitiators include 2-methyl-2-hydroxypropiophenone and 1-[4-(2-hydroxyethyl)phenyl]-2-methylpropan-1-one. A non-limiting example of the aromatic sulfonyl chloride photoinitiators is 2-naphthalenesulfonyl chloride. A non-limiting example of the photoactive oxime photoinitiators is 1-phenyl-1,1-propanedione-2-(O-ethoxycarbonyl)-oxime. A non-limiting example of the benzoin photoinitiators is benzoin. A non-limiting example of the benzil photoinitiators is benzil. Non-limiting examples of the benzophenone photoinitiators include benzophenone, benzoylbenzoic acid, 3,3′-dimethyl-4-methoxybenzophenone, polyvinylbenzophenones, and α-hydroxycyclohexyl phenyl ketone. A non-limiting example of the ketal photoinitiators is benzil dimethyl ketal. Non-limiting examples of the thioxanthone photoinitiators include thioxanthone, 2-chlorothioxanthone, 2-methylthioxanthone, 2,4-dimethylthioxanthone, isopropylthioxanthone, 2,4-diisopropylthioxanthone, and dodecylthioxanthone. Non-limiting examples of the acylphosphine oxide photoinitiators include diphenyl(2,4,6-trimethylbenzoyl)phosphine oxide and phenylbis(2,4,6-trimethylbenzoyl)phosphine oxide. A non-limiting example of the titanocene photoinitiators is bis(η⁵-2,4-cyclopentadien-1-yl)-bis(2,6-difluoro-3-(1H-pyrrol-1-yl)-phenyl)titanocene. The photoinitiator may be used in any common amount, which can be selected within the range of typically 0.01 to 3 parts by mass, and preferably 0.1 to 1.5 parts by mass, per 100 parts by mass of the monomer components.

The pressure-sensitive adhesive layer preferably includes a tackifier resin. The pressure-sensitive adhesive layer, when including a tackifier resin, tends to provide good adhesion even though having a small thickness. Since the pressure-sensitive adhesive sheet has a total thickness of 100 μm or less, and the metal layer included in the substrate layer has a thickness of 10 to 80 μm, the pressure-sensitive adhesive layer in the pressure-sensitive adhesive sheet inevitably has a small thickness. In particular, when the pressure-sensitive adhesive sheet is a double-sided pressure-sensitive adhesive sheet, each pressure-sensitive adhesive layer has a still smaller thickness. However, the pressure-sensitive adhesive layer, when including the acrylic polymer as the base polymer in combination with a tackifier resin, has excellent adhesion to an internal component of a portable electronic device and resists separation.

Non-limiting examples of the tackifier resin include phenolic tackifier resins, terpene tackifier resins, rosin tackifier resins, hydrocarbon tackifier resins, epoxy tackifier resins, polyamide tackifier resins, elastomer tackifier resins, and ketone tackifier resins. Non-limiting examples of the tackifier resin also include low polymers (oligomers) of a (meth)acrylic alkyl ester, such as low polymers between dicyclopentanyl methacrylate (DCPMA) and methyl methacrylate (MMA). The pressure-sensitive adhesive layer may include each of different tackifier resins alone or in combination.

Non-limiting examples of the phenolic tackifier resins include terpene phenol resins, hydrogenated terpene phenol resins, alkyl phenol resins, and rosin phenol resins. The terpene phenol resins are polymers each including a terpene residue and a phenol residue, and are exemplified by, but not limited to, copolymers between a terpene and a phenol compound (terpene-phenol copolymer resins); and phenol-modified terpene resins, which are phenol-modified products derived from terpene homopolymers or copolymers. Non-limiting examples of the terpene constituting the terpene phenol resins include monoterpenes such as α-pinene, β-pinene, and limonenes (such as d-limonene, l-limonene, and d/l-limonene (dipentene)). The hydrogenated terpene phenol resins are resins having a structure resulting from hydrogenation of the terpene phenol resins. The alkyl phenol resins are resins derived from an alkylphenol and formaldehyde (oily phenolic resins). Non-limiting examples of the alkyl phenol resins include novolak resins and resol resins. The rosin phenol resins are phenol-modified products derived from rosins or rosin derivatives described later. Such a rosin phenol resin is obtained typically by a process of adding phenol to a rosin or the after-mentioned rosin derivative using an acid catalyst, and thermally polymerizing the resulting adduct.

Non-limiting examples of the terpene tackifier resins include polymers of terpenes (typically monoterpenes) such as α-pinene, β-pinene, d-limonene, l-limonene, and dipentene. The polymers derived from the terpenes may each be a homopolymer derived from one terpene alone, or a copolymer derived from two or more different terpenes. Non-limiting examples of the homopolymer derived from one terpene alone include α-pinene polymers, β-pinene polymers, and dipentene polymers. The modified terpene tackifier resins are resins resulting from modification of the terpene resins (modified terpene resins). Non-limiting examples of the modified terpene resins include styrene-modified terpene resins and hydrogenated terpene resins.

Non-limiting examples of the rosin tackifier resins include rosins and rosin derivative resins. Non-limiting examples of the rosins include unmodified rosins (raw rosins) such as gum rosin, wood rosin, and tall oil rosin; and modified rosins resulting from modification of these unmodified rosins typically through hydrogenation, disproportionation, or polymerization, such as hydrogenated rosins, disproportionated rosins, polymerized rosins, and other chemically modified rosins. Examples of the rosin derivative resins include derivatives of the rosins. Non-limiting examples of the rosin derivative resins include rosin esters such as unmodified rosin esters, which are esters between an unmodified rosin and an alcohol, and modified rosin esters, which are esters between a modified rosin and an alcohol; unsaturated fatty acid-modified rosins, resulting from modification of a rosin with an unsaturated fatty acid; unsaturated fatty acid-modified rosin esters, resulting from modification of a rosin ester with an unsaturated fatty acid; rosin alcohols, resulting from reduction treatment of carboxy(s) of rosins or the rosin derivatives; and metal salts of rosins or the rosin derivatives. Specific, but non-limiting examples of the rosin esters include methyl esters, triethylene glycol esters, glycerol esters, or pentaerythritol esters of unmodified rosins or modified rosins.

Non-limiting examples of the hydrocarbon tackifier resins include aliphatic hydrocarbon resins, aromatic hydrocarbon resins, alicyclic hydrocarbon resins, aliphatic-aromatic petroleum resins (such as styrene-olefin copolymers), aliphatic-alicyclic petroleum resins, hydrogenated hydrocarbon resins, coumarone resins, and coumarone-indene resins.

The tackifier resin has a softening point (softening temperature) of preferably 80° C. or higher, more preferably 100° C. or higher, still more preferably 135° C. or higher, and particularly preferably 140° C. or higher, although the tackifier resin may have any other softening point. Such a tackifier resin having a softening point of 80° C. or higher (in particular, 135° C. or higher) allows the formed pressure-sensitive adhesive layer to have still better adhesion even though having a small thickness. The softening point is typically 200° C. or lower, and preferably 180° C. or lower, from the viewpoint of providing better adhesion to an adherend. In particular, the tackifier resin is preferably selected from the terpene phenol tackifier resins that have a softening point within the range. The softening point of the tackifier resin can be measured according to the testing method for softening point (ball and ring method) prescribed in JIS K 2207.

The tackifier resin has a hydroxyl value of preferably 20 mg KOH/g or more, more preferably 30 mg KOH/g or more, still more preferably 50 mg KOH/g or more, and particularly preferably 70 mg KOH/g or more, although the tackifier resin may have any other hydroxyl value. Such a tackifier resin having a hydroxyl value of 20 mg KOH/g or more (in particular, 70 mg KOH/g or more) allows the formed pressure-sensitive adhesive layer to have still better adhesion even though having a small thickness. The hydroxyl value is typically 200 mg KOH/g or less, preferably 180 mg KOH/g or less, more preferably 160 mg KOH/g or less, and still more preferably 140 mg KOH/g or less. In particular, the tackifier resin is preferably selected from the terpene phenol tackifier resins that have a hydroxyl value within the range. The hydroxyl value of the tackifier resin can be a value measured by the potentiometric titration method prescribed in JIS K 0070:1992.

The pressure-sensitive adhesive layer may contain the tackifier resin in an amount of typically 1 part by mass or more (e.g., 1 to 100 parts by mass), preferably 5 parts by mass or more, more preferably 10 parts by mass or more, and still more preferably 15 parts by mass or more, per 100 parts by mass of the totality of the base polymer, although the amount is not limited. The pressure-sensitive adhesive layer, when containing the tackifier resin in an amount of 1 part by mass or more, has still better adhesion even though having a small thickness. The amount is preferably 50 parts by mass or less, more preferably 40 parts by mass or less, and still more preferably 30 parts by mass or less, for excellent thermostable cohesive force. In particular, the pressure-sensitive adhesive layer preferably includes the terpene phenol tackifier resin (in particular, the terpene phenol tackifier resin that has a softening point within the range) in an amount within the range.

The pressure-sensitive adhesive layer preferably includes a rust inhibitor (corrosion inhibitor). As described above, the acrylic polymer in the acrylic pressure-sensitive adhesive is preferably derived from monomer components including, as a copolymerizable monomer, at least one of a carboxy-containing monomer and an acid anhydride monomer. However, the carboxy-containing monomer and/or the acid anhydride monomer, which can remain in the pressure-sensitive adhesive layer, may corrode the metal layer and a metal which can be used as or in the internal part (internal component) of the portable electronic device. The incorporation of such a rust inhibitor may eliminate or minimize the corrosion. The pressure-sensitive adhesive layer may include each of different rust inhibitors alone or in combination.

Non-limiting examples of the rust inhibitor include amine rust inhibitors, azole rust inhibitors, and nitrite rust inhibitors; as well as ammonium benzoate, ammonium phthalate, ammonium stearate, ammonium palmitate, ammonium oleate, ammonium carbonate, benzoic acid dicyclohexylamine salt, urea, urotropin, thiourea, phenyl carbamate, and cyclohexylammonium-N-cyclohexylcarbamate (CHC).

Among them, the rust inhibitor is preferably selected from azole rust inhibitors. Such azole rust inhibitors allow the pressure-sensitive adhesive layer to be higher in cohesive force (such as thermostable cohesive force) and to provide still better adhesion to the internal component of the portable electronic device, while restraining corrosion of the metal layer and the metal to be used as or in the internal part (internal component) of the portable electronic device. The pressure-sensitive adhesive layer, when including an isocyanate crosslinker in combination with a crosslinker of another type in a formulation including an azole rust inhibitor, can advantageously strike a balance between cohesive force (such as thermostable cohesive force) and metal corrosion-protection performance.

The azole rust inhibitors are preferably those including, as an active ingredient, an azole compound which is a 5-membered ring aromatic compound including two or more heteroatoms, in which at least one of the heteroatoms is nitrogen.

Non-limiting examples of the azole compound include azoles such as imidazole, pyrazole, oxazole, isoxazole, triazole, isothiazole, selenazole, 1,2,3-triazole, 1,2,4-triazole, 1,2,5-oxadiazole, 1,3,4-oxadiazole, 1,2,3-thiadiazole, 1,2,4-thiadiazole, 1,3,4-thiadiazole, tetrazole, and 1,2,3,4-thiatriazole; derivatives of them; amine salts of them; and metal salts of them. Non-limiting examples of the derivatives of azoles include compounds having a structure including a fused ring between an azole ring and another ring (such as a benzene ring). Specific examples of such compounds include indazole, benzimidazole, benzotriazole (i.e., 1,2,3-benzotriazole, which has a structure in which the azole ring of 1,2,3-triazole is fused with a benzene ring), and benzothiazole; and derivatives of them, exemplified by alkylbenzotriazoles (such as 5-methylbenzotriazole, 5-ethylbenzotriazole, 5-n-propylbenzotriazole, 5-isobutylbenzotriazole, and 4-methylbenzotriazole), alkoxybenzotriazoles (such as 5-methoxybenzotriazole), alkylaminobenzotriazoles, alkylaminosulfonylbenzotriazoles, mercaptobenzotriazoles, hydroxybenzotriazoles, nitrobenzotriazoles (such as 4-nitrobenzotriazole), halobenzotriazoles (such as 5-chlorobenzotriazole), hydroxyalkylbenzotriazoles, hydrobenzotriazole, aminobenzotriazoles, (substituted aminomethyl)-tolyltriazoles, carboxybenzotriazoles, N-alkylbenzotriazoles, bisbenzotriazole, naphthotriazoles, mercaptobenzothiazoles, and aminobenzothiazoles, as well as amine salts of them, and metal salts of them. Other examples of the azole derivatives include azole derivatives having a non-fused ring structure, such as 3-amino-1,2,4-triazole, 5-phenyl-1H-tetrazole, and other compounds having a structure including a substituent on a non-fused azole ring.

The azole compound is preferably selected from benzotriazole compounds. The benzotriazole compounds are compounds having a benzotriazole skeleton, of which preferred from the viewpoint of further eliminating or minimizing metal corrosion are compounds represented by Formula (1):

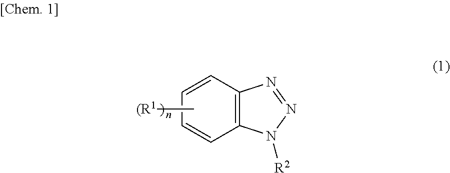

In Formula (1), each of R¹ represents a substituent on the benzene ring. Non-limiting examples of the substituent include C₁-C₆ alkyls, C₁-C₆ alkoxys, C₆-C₁₄ aryls, carboxy, C₂-C₆ carboxyalkyls, amino, mono- or di-(C₁-C₁₀ alkyl)aminos, amino-C₁-C₆ alkyls, mono- or di-(C₁-C₁₀ alkyl)amino-C₁-C₆ alkyls, mercapto, and C₁-C₆ alkoxy-carbonyls.

In Formula (1), n represents an integer of 0 to 4. When n is an integer of 2 or more, nR¹s in Formula (1) may be identical or different.

In Formula (1), R² represents a substituent on a nitrogen atom. R² represents, for example, hydrogen, C₁-C₁₂ alkyl, C₁-C₁₂ alkoxy, C₆-C₁₄ aryl, amino, mono- or di-(C₁-C₁₀ alkyl)amino, amino-C₁-C₆ alkyl, mono- or di-(C₁-C₁₀ alkyl)amino-C₁-C₆ alkyl, mercapto, or C₁-C₁₂ alkoxycarbonyl. R¹ and R² may be identical or different.

Of the compounds represented by Formula (1), preferred are 1,2,3-benzotriazole, 5-methylbenzotriazole, 4-methylbenzotriazole, and carboxybenzotriazole.

Non-limiting examples of the amine rust inhibitors include ammonia; hydroxy-containing amine compounds such as 2-amino-2-methyl-1-propanol, monoethanolamine, monoisopropanolamine, diethylethanolamine, and ammonia water; cyclic amines such as morpholine; cyclic alkylamine compounds such as cyclohexylamine; linear-alkylamines such as 3-methoxypropylamine. Non-limiting examples of the nitrite rust inhibitors include dicyclohexylammonium nitrite (DICHAN), diisopropylammonium nitrite (DIPAN), sodium nitrite, potassium nitrite, and calcium nitrite.

The pressure-sensitive adhesive layer may include the rust inhibitor in a proportion of preferably 0.01 part by mass or more, more preferably 0.05 part by mass or more, still more preferably 0.1 part by mass or more, still more preferably 0.3 part by mass or more, and particularly preferably 0.5 part by mass or more, per 100 parts by mass of the totality of the base polymer, for still better metal protection from corrosion. However, the pressure-sensitive adhesive layer may include the rust inhibitor in any other proportion. The proportion is preferably less than 8 parts by mass, more preferably 6 parts by mass or less, and still more preferably 5 parts by mass or less. In particular, the pressure-sensitive adhesive layer preferably includes the azole rust inhibitor(s) in a proportion within the range. The pressure-sensitive adhesive layer, when including the azole rust inhibitor(s) in a proportion within the range, can be higher in cohesive force (such as thermostable cohesive force) and can provide still better adhesion to an internal component of a portable electronic device, while restraining corrosion of the metal layer and the metal to be used as or in the internal part (internal component) of the portable electronic device.

The pressure-sensitive adhesive layer may include the rust inhibitor(s) in a proportion of preferably 0.2 part by mass or more, more preferably 0.5 part by mass or more, still more preferably 1 part by mass or more, still more preferably 1.5 parts by mass or more, still more preferably 4 parts by mass or more, and particularly preferably 6 parts by mass or more, per 10 parts by mass of the totality of the at least one of a carboxy-containing monomer and an acid anhydride monomer, which can be contained in the monomer components to form the acrylic polymer. The pressure-sensitive adhesive layer, when including the rust inhibitor(s) in a proportion of 0.2 part by mass or more, can more eliminate or minimize metal corrosion. The proportion may be typically 30 parts by mass or less, 20 parts by mass or less, 15 parts by mass or less, 10 parts by mass or less, 5 parts by mass or less, or 3 parts by mass or less, for advantageous combination of the metal corrosion restraining effect and the retainability for the internal component. In particular, the pressure-sensitive adhesive layer preferably includes the azole rust inhibitor(s) in a proportion within the range.

The pressure-sensitive adhesive layer preferably includes a crosslinker. Such a crosslinker crosslinks, for example, the acrylic polymer in the acrylic pressure-sensitive adhesive layer and controls the gel fraction. The pressure-sensitive adhesive layer may include each of different crosslinkers alone or in combination.

Non-limiting examples of the crosslinker include isocyanate crosslinkers, epoxy crosslinkers, melamine crosslinkers, peroxide crosslinkers, urea crosslinkers, metal alkoxide crosslinkers, metal chelate crosslinkers, metal salt crosslinkers, carbodiimide crosslinkers, oxazoline crosslinkers, aziridine crosslinkers, amine crosslinkers, hydrazine crosslinkers, silicone crosslinkers, and silane crosslinkers (silane coupling agents).

The pressure-sensitive adhesive layer may include the crosslinker in a proportion of preferably 0.001 to 20 parts by mass, more preferably 0.01 to 15 parts by mass, and particularly preferably 0.5 to 10 parts by mass, per 100 parts by mass of the totality of the base polymer, although the pressure-sensitive adhesive layer may include the crosslinker in any other proportion.

The isocyanate crosslinkers are multifunctional isocyanate compounds, which are compounds having two or more isocyanate groups on average per molecule. Non-limiting examples of the isocyanate crosslinkers include aliphatic polyisocyanates, alicyclic polyisocyanates, and aromatic polyisocyanates.

Non-limiting examples of the aliphatic polyisocyanates include 1,2-ethylene diisocyanate; tetramethylene diisocyanates such as 1,2-tetramethylene diisocyanate, 1,3-tetramethylene diisocyanate, and 1,4-tetramethylene diisocyanate; hexamethylene diisocyanates such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, and 2,5-hexamethylene diisocyanate; and other aliphatic diisocyanates such as 2-methyl-1,5-pentane diisocyanate, 3-methyl-1,5-pentane diisocyanate, and lysine diisocyanate.

Non-limiting examples of the alicyclic polyisocyanates include isophorone diisocyanate; cyclohexyl diisocyanates such as 1,2-cyclohexyl diisocyanate, 1,3-cyclohexyl diisocyanate, and 1,4-cyclohexyl diisocyanate; cyclopentyl diisocyanates such as 1,2-cyclopentyl diisocyanate and 1,3-cyclopentyl diisocyanate; and other alicyclic diisocyanates such as hydrogenated xylylene diisocyanate, hydrogenated tolylene diisocyanate, hydrogenated diphenylmethane diisocyanate, hydrogenated tetramethylxylene diisocyanate, and 4,4′-dicyclohexylmethane diisocyanate.

Non-limiting examples of the aromatic polyisocyanates include 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, 4,4′-diphenyl ether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, and xylylene-1,3-diisocyanate.

Non-limiting examples of the isocyanate crosslinkers also include commercial products such as a trimethylolpropane/tolylene diisocyanate adduct (trade name CORONATE L, supplied by TOSOH CORPORATION), a trimethylolpropane/hexamethylene diisocyanate adduct (trade name CORONATE HL, supplied by TOSOH CORPORATION), and a trimethylolpropane/xylylene diisocyanate adduct (trade name TAKENATE D-110N, supplied by Mitsui Chemicals Inc.).

In an aqueous dispersion of a modified acrylic polymer prepared by emulsion polymerization, an isocyanate crosslinker does not have to exist but, where necessary, may exist as a blocked isocyanate crosslinker, because such a blocked isocyanate crosslinker has high reactivity with water.

The isocyanate crosslinker(s), when used as the crosslinker, may be present in a proportion of preferably 0.5 part by mass or more, more preferably 1 part by mass or more, and still more preferably 1.5 parts by mass or more, per 100 parts by mass of the totality of the base polymer, although the isocyanate crosslinker(s) may be present in any other proportion. The proportion is preferably 10 parts by mass or less, more preferably 8 parts by mass or less, still more preferably 5 parts by mass or less, and particularly preferably 3 parts by mass or less.

Non-limiting examples of the epoxy crosslinkers (multifunctional epoxides) include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ethers, polypropylene glycol diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, diglycidyl o-phthalate, triglycidyl-tris(2-hydroxyethyl)isocyanurate, resorcinol diglycidyl ether, and bisphenol-S diglycidyl ether; as well as epoxy resins each having two or more epoxy groups per molecule. Non-limiting examples of the epoxy crosslinkers also include commercial products such as one available under the trade name of TETRAD C (from MITSUBISHI GAS CHEMICAL COMPANY, INC.).

The epoxy crosslinker(s), when used as the crosslinker, may be present in a proportion of preferably from greater than 0 part by mass to 1 part by mass, more preferably 0.001 to 0.5 part by mass, still more preferably 0.002 to 0.2 part by mass, still more preferably 0.005 to 0.1 part by mass, and particularly preferably 0.008 to 0.05 part by mass, per 100 parts by mass of the totality of the base polymer, although the epoxy crosslinker(s) may be present in any other proportion.

As the peroxide crosslinkers, any of peroxide crosslinkers that generate active radical species upon application of heat to cause the base polymer to crosslink is appropriately usable, from a view point of workability and stability, of which peroxides having a one-minute half-life temperature of 80° C. to 160° C. are preferred, and peroxides having a one-minute half-life temperature of 90° C. to 140° C. are more preferred.

Non-limiting examples of the peroxide crosslinkers include di(2-ethylhexyl) peroxydicarbonate (one-minute half-life temperature: 90.6° C.), di(4-t-butylcyclohexyl) peroxydicarbonate (one-minute half-life temperature: 92.1° C.), di-sec-butyl peroxydicarbonate (one-minute half-life temperature: 92.4° C.), t-butyl peroxyneodecanoate (one-minute half-life temperature: 103.5° C.), t-hexyl peroxypivalate (one-minute half-life temperature: 109.1° C.), t-butyl peroxypivalate (one-minute half-life temperature: 110.3° C.), dilauroyl peroxide (one-minute half-life temperature: 116.4° C.), di-n-octanoyl peroxide (one-minute half-life temperature: 117.4° C.), 1,1,3,3-tetramethylbutyl peroxy-2-ethylhexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), t-butyl peroxyisobutyrate (one-minute half-life temperature: 136.1° C.), and 1,1-di(t-hexylperoxy)cyclohexane (one-minute half-life temperature: 149.2° C.)

The “half-life” of a peroxide crosslinker is an index indicating the decomposition rate of the peroxide and refers to the time required for the amount of the peroxide to fall from a chosen value to half that value. Decomposition temperatures for any (arbitrary) half lives, and half lives at any temperatures are described typically in manufactures' catalogs, such as “Organic Peroxides Catalog” 9th Ed. (May, 2003) available from NOF Corporation. The amount of the residual peroxide after the reaction treatment can be measured by a technique such as high-performance liquid chromatography (HPLC). More specifically, the peroxide residual amount after the reaction treatment can be measured typically by the following procedure. About 0.2 g of a tested pressure-sensitive adhesive after the reaction treatment is sampled, immersed in 10 ml of ethyl acetate, extracted with shaking in a shaker at 25° C., 120 rpm for 3 hours, and left stand at room temperature for 3 days. Next, the resulting article is combined with 10 ml of acetonitrile, shaken at 25° C., 120 rpm for 30 minutes, and filtered through a membrane filter (0.45 μm) to give an extract. About 10 μl of the extract is charged into a HPLC system, analyzed, and the analyzed amount is defined as the residual amount of the peroxide after the reaction treatment.

The peroxide crosslinker(s), when used as the crosslinker, may be present in a proportion of preferably 2 parts by mass or less, more preferably 0.02 to 2 parts by mass, and still more preferably 0.05 to 1 part by mass, per 100 parts by mass of the base polymer, although the peroxide crosslinker may be present in any other proportion.

The crosslinker for use herein may further include at least one of an organic crosslinker and a multifunctional metal chelate. The multifunctional metal chelate is a chelate including a multifunctional metal covalently or coordinately bonded to an organic compound. Non-limiting examples of the multifunctional metal atom include Al, Cr, Zr, Co, Cu, Fe, Ni, V, Zn, In, Ca, Mg, Mn, Y, Ce, Sr, Ba, Mo, La, Sn, and Ti. A non-limiting example of the atom in the organic compound to which the multifunctional metal is covalently or coordinately bonded is oxygen atom, and non-limiting examples of the organic compound include alkyl esters, alcohol compounds, carboxylic acid compounds, ether compounds, and ketone compounds.

Among them, the pressure-sensitive adhesive layer preferably includes an isocyanate crosslinker as the crosslinker, and more preferably includes such an isocyanate crosslinker in combination with another crosslinker. The other crosslinker is preferably selected from epoxy crosslinkers. The crosslinker(s) as above allows the pressure-sensitive adhesive layer to have still better adhesion even though having a small thickness, when used in combination with the acrylic polymer (in particular, when used in combination with the preferred acrylic polymer).

The pressure-sensitive adhesive layer may further contain, as needed, one or more additives within ranges not adversely affecting the advantageous effects of the present invention. Non-limiting examples of the additives include cross-linking promoters, age inhibitors, fillers (such as organic fillers and inorganic fillers), colorants (such as pigments and dyes), antioxidants, plasticizers, softeners, surfactants, antistatic agents, surface lubricants, leveling agents, photostabilizers, ultraviolet absorbers, polymerization inhibitors, particulates, and foil-like substances. The pressure-sensitive adhesive layer may contain each of different additives alone or in combination.

The pressure-sensitive adhesive layer preferably includes approximately no conductive particle such as metal powder and has a content of such conductive particles of preferably 5 mass percent or less, more preferably 2 mass percent or less, still more preferably 1 mass percent or less, and particularly preferably 0.5 mass percent or less, of the totality (100 mass percent) of the pressure-sensitive adhesive layer.

The pressure-sensitive adhesive layer has a thickness of preferably 1 to 90 μm, more preferably 3 to 50 μm, still more preferably 5 to 30 μm, and particularly preferably 10 to 30 μm, although the pressure-sensitive adhesive layer may have any other thickness. When the pressure-sensitive adhesive sheet is a double-sided pressure-sensitive adhesive sheet, the term “thickness” of the pressure-sensitive adhesive layer refers to the thickness of one of the two pressure-sensitive adhesive layers. The pressure-sensitive adhesive layer, when having a thickness of 1 μm or more, allows the pressure-sensitive adhesive sheet to have still higher adhesion. The pressure-sensitive adhesive layer, when having a thickness of 90 μm or less, allows the pressure-sensitive adhesive sheet to have a smaller total thickness.

The pressure-sensitive adhesive sheet has a thickness ratio of the pressure-sensitive adhesive layer to the substrate layer of preferably 0.05 to 1.0, more preferably 0.07 to 0.6, and still more preferably 0.08 to 0.5, although the pressure-sensitive adhesive sheet may have any other thickness ratio. The pressure-sensitive adhesive sheet, which has a total thickness of 100 μm or less, when having a thickness ratio as above of 0.05 or more, has still better adhesion to an internal component of a portable electronic device, because the pressure-sensitive adhesive layer can more sufficiently exhibit adhesion. The pressure-sensitive adhesive sheet, when having a thickness ratio as above of 1.0 or less, has still better shielding performance against electromagnetic waves in a low-frequency region, because the metal layer in the substrate layer has a relatively large thickness. When the pressure-sensitive adhesive sheet is a double-sided pressure-sensitive adhesive sheet, the term “thickness” of the pressure-sensitive adhesive layer refers to the thickness of one of the two pressure-sensitive adhesive layers. The thickness of the pressure-sensitive adhesive sheet is as described later.

The pressure-sensitive adhesive layer may be prepared by any process not limited, but may be prepared typically by applying a pressure-sensitive adhesive (pressure-sensitive adhesive composition) including the base polymer onto the substrate layer or a release liner, and drying and thereby curing the resulting pressure-sensitive adhesive composition layer; or by applying the pressure-sensitive adhesive composition onto the substrate layer or a release liner, and irradiating the resulting pressure-sensitive adhesive composition layer with actinic radiation to cure the layer. As needed, the layer may further be dried by heating.

Non-limiting examples of the actinic radiation include ionizing radiation such as alpha rays, beta rays, gamma rays, neutron beams, and electron beams; and ultraviolet radiation, of which ultraviolet radiation is preferred. The irradiation of the actinic radiation is not limited in conditions such as irradiation energy, irradiation time, and irradiation technique.

The pressure-sensitive adhesive composition can be prepared by a known or common process. For example, the pressure-sensitive adhesive composition, when being a solvent-borne pressure-sensitive adhesive composition, can be prepared by adding, as needed, one or more additives to a solution containing the base polymer. When the base polymer is the acrylic polymer, the pressure-sensitive adhesive composition, typically when being an actinic radiation-curable pressure-sensitive adhesive composition, can be prepared by mixing, as needed, one or more additives with a mixture of monomer components to form the acrylic polymer, or with a partially polymerized product of the mixture.

The application (coating) of the pressure-sensitive adhesive composition may be performed using a known coating technique. For example, the application may be performed using a coater such as a rotogravure roll coater, reverse roll coater, kiss-contact roll coater, dip roll coater, bar coater, knife coater, spray coater, comma coater, or direct coater.

The drying by heating of the solvent-borne pressure-sensitive adhesive composition operates at a temperature of preferably 40° C. to 200° C., more preferably 50° C. to 180° C., and still more preferably 70° C. to 170° C.; for a drying time of typically 5 seconds to 20 minutes, preferably 5 seconds to 10 minutes, and more preferably 10 seconds to 5 minutes, although any other appropriate drying time can be employed suitably.

The acrylic pressure-sensitive adhesive layer, when to form by actinic radiation irradiation, can form while the acrylic polymer forms from the monomer components. The monomer components can be used in actinic radiation irradiation as a syrup resulting from partial polymerization of the monomer components. The ultraviolet irradiation may operate using a light source such as a high-pressure mercury lamp, low-pressure mercury lamp, or metal halide lamp.

The pressure-sensitive adhesive sheet can be produced according to a known or common production method. The pressure-sensitive adhesive sheet may be obtained by a direct process or a transfer process. In the direct process, the pressure-sensitive adhesive layer directly forms on the substrate layer. In the transfer process, the pressure-sensitive adhesive layer once forms on a release liner and is then transferred (laminated) onto the substrate layer to provide the pressure-sensitive adhesive layer on the substrate layer.

The pressure-sensitive adhesive sheet has a total thickness of 100 μm or less (e.g., 5 to 100 μm), preferably 80 μm or less (e.g., 10 to 80 μm), and more preferably 60 μm or less (e.g., 15 to 60 μm). As used herein, the term “total thickness of (the) pressure-sensitive adhesive sheet” refers to as follows. When the pressure-sensitive adhesive sheet is a single-sided pressure-sensitive adhesive sheet, the term refers to the thickness (dimension) from the surface of the side of the substrate layer opposite to the pressure-sensitive adhesive layer, to the adhesive face of the pressure-sensitive adhesive layer. When the pressure-sensitive adhesive sheet is a double-sided pressure-sensitive adhesive sheet, the term refers to the thickness (dimension) from the adhesive face of one pressure-sensitive adhesive layer, through the substrate layer, to the adhesive face of the other pressure-sensitive adhesive layer. The “total thickness of the pressure-sensitive adhesive sheet” does not include the thickness of the after-mentioned print layer and the thickness of the after-mentioned release liner.

The pressure-sensitive adhesive sheet has an electric field shielding effect of 20 dB or more, and preferably 25 dB or more, as measured by the KEC method (“electromagnetic shielding effect measurement method” prescribed by KEC Electronic Industry Development Center) at a frequency of 100 kHz to 1000 kHz.

The pressure-sensitive adhesive sheet has a magnetic field shielding effect of 5 dB or more, and preferably 5.5 dB or more, as measured by the KEC method at a frequency of 100 kHz to 1000 kHz. The pressure-sensitive adhesive sheet, when having an electric field shielding effect of 20 dB or more and a magnetic field shielding effect of 5 dB or more at a frequency within the range, has excellent shielding performance against electromagnetic waves in the low-frequency region. With an increasing electric field shielding effect and an increasing magnetic field shielding effect, the pressure-sensitive adhesive sheet has higher shielding performance against electromagnetic waves in a low-frequency region. The upper limits of the electric field shielding effect and the magnetic field shielding effect are not limited.

The pressure-sensitive adhesive sheet has an adhesive strength (tackiness) to a PET film of preferably 5 N/25 mm or more, more preferably 10 N/25 mm or more, and still more preferably 15 N/25 mm or more, although the pressure-sensitive adhesive sheet may have any other adhesive strength. The pressure-sensitive adhesive sheet, when having an adhesive strength of 5 N/25 mm or more, has excellent adhesion to an internal component of a portable electronic device and resists separation even when the internal component evolves heat. The higher the adhesive strength, the better, and the adhesive strength is not limited in its upper limit. The adhesive strength herein is a value measured at a temperature of 23° C., a peel angle of 180°, and a peel rate of 300 mm/minute. When the pressure-sensitive adhesive sheet is a double-sided pressure-sensitive adhesive sheet, the adhesive strength of at least one pressure-sensitive adhesive layer (in particular, at least the pressure-sensitive adhesive layer to face (to be applied to) an internal component of a portable electronic device) preferably falls within the range.

The pressure-sensitive adhesive sheet has a discoloration time of preferably 200 hours or longer, and more preferably 500 hours or longer, where the discoloration time is the time by which discoloration (change in color) of the metal layer is visually observed at a temperature of 65° C. and relative humidity of 90%. The pressure-sensitive adhesive sheet, when having this configuration, highly resists corrosion in the metal layer and in the internal component of the portable electronic device. When the pressure-sensitive adhesive sheet is a double-sided pressure-sensitive adhesive sheet, it is preferred that at least one pressure-sensitive adhesive layer (in particular, at least the pressure-sensitive adhesive layer to face to the internal component of the portable electronic device), and in particular, both the pressure-sensitive adhesive layers, meet the condition for the performance.

The pressure-sensitive adhesive sheet may further include one or more other layers, in addition to the substrate layer and the pressure-sensitive adhesive layer. A non-limiting example of the other layers is a black layer. The black layer may be disposed in the following manner. For example, when the pressure-sensitive adhesive sheet is a single-sided pressure-sensitive adhesive sheet, the black layer is disposed on the surface of the substrate layer opposite to the pressure-sensitive adhesive layer. When the pressure-sensitive adhesive sheet is a double-sided pressure-sensitive adhesive sheet, the black layer is disposed on, of the two surfaces of the substrate layer, the surface that faces the pressure-sensitive adhesive layer and faces toward the outer side of the portable electronic device. The black layer, when disposed, is preferably disposed on the entire surface of the substrate layer, from the viewpoint of graphical design function.

The category “black layer” includes all layers that are black in color and generally refers to a layer containing a black colorant. The black layer has a surface typically having a lightness L of 40 or less (typically 35 or less, and preferably 30 or less) as specified by the Lab color space. The pressure-sensitive adhesive sheet, when including the black layer, provides an excellent appearance when applied to a graphite slab. In particular, this configuration provides a still better appearance when the substrate layer has a low surface gloss (e.g., a gloss of 10 or less at a specular angle of 60°), and the pressure-sensitive adhesive sheet has a low light transmittance (e.g., 12% to 30%). The Lab color space is in conformity to the prescription recommended by the International Commission on Illumination in 1976, or to the prescription defined in JIS Z 8729. The black layer is preferably a black print layer lying typically on the substrate layer.

The black layer preferably contains a black colorant and a binder. The binder for use herein can be selected from materials known in the field of painting or printing. Non-limiting examples of the binder include polyurethanes, phenolic resins, epoxy resins, urea melamine resins, and poly(methyl methacrylate)s. The black layer may further include a white pigment (such as titanium dioxide, zinc white, or white lead), or another colorant, or may include approximately no colorant other than the black colorant.

The black colorant can be selected from organic or inorganic colorants (such as pigments and dyes). Non-limiting examples of the black colorant include carbon black, acetylene black, graphite, copper oxide, manganese dioxide, aniline black, perylene black, black titanium oxide, cyanine black, activated carbon, ferrite, magnetite, chromium oxide, iron oxide, molybdenum disulfide, chromium complexes, and anthraquinone colorants. Among them, carbon black is preferred. The black layer may include each of different black colorants alone or in combination. The black colorant is preferably carbon black that has an average particle diameter of typically 10 nm to 500 nm (preferably 10 nm to 120 nm), although any other black colorants may be employed. The average particle diameter refers to a 50%-volume average particle diameter (D50), which is a particle size at an integrated value of 50% in a particle size distribution determined through laser scattering-diffractometry, using a particle size distribution analyzer.

The black layer may contain the black colorant in a content of typically 1 mass percent or more, preferably 2 mass percent or more, more preferably 5 mass percent or more, and still more preferably 15 mass percent or more, of the totality (100 mass percent) of the black layer, although the content may be determined according typically to the required color (tint) and texture, and is not limited. The content of the black colorant is typically 65 mass percent or less; and, for excellent inspectability, preferably 30 mass percent or less, more preferably 15 mass percent or less, and still more preferably 8 mass percent or less.

The black layer has a thickness of typically 0.1 μm or more, preferably 0.5 μm or more, more preferably 0.7 μm or more, still more preferably 0.8 μm or more, and particularly preferably 1 μm or more. The thickness of the black layer is typically 10 μm or less, preferably 7 μm or less, more preferably 5 μm or less, still more preferably 3 μm or less, and particularly preferably 2 μm or less. The thickness of the black layer, when including two or more layers, refers to the total thickness of the layers. When the black layer includes such layers, each black layer preferably has a thickness of typically about 0.5 μm to about 2 μm.

The black layer can form by applying a black-layer-forming composition to the substrate layer. Non-limiting examples of the black-layer-forming composition includes solvent-borne compositions, UV-curable compositions, and thermosetting compositions. The black layer can form using a known means or process employed in the formation of such black layers. For example, preferably employed is a process of forming such a black layer (black print layer) by printing such as gravure printing, flexographic printing, or offset printing. Among them, gravure printing is particularly preferred. The gravure printing enables relatively easy control of the color (tint) of the black layer by controlling a plate to be used in the gravure printing.

The black layer may be a single layer, or may include layers. The black layer, when to include layers, can form typically by repeating the application (e.g., printing) of the black-layer-forming composition. The types and the proportions of the colorants and the binders contained in the individual black layers may be identical or different.

The pressure-sensitive adhesive sheet may carry a release liner on the surface (adhesive face) of the pressure-sensitive adhesive layer(s) before use. The pressure-sensitive adhesive sheet, when being a double-sided pressure-sensitive adhesive sheet, may be protected on its two adhesive faces respectively by two release liners, or may be rolled with one release liner having release surfaces on both sides, to form a roll to thereby be protected on its adhesive faces. The release liner(s) is used as a protectant for the pressure-sensitive adhesive layer(s) and will be removed when the sheet is applied to an adherend or adherends. The pressure-sensitive adhesive sheet does not always have to carry such a release liner.

The release liner can be selected typically from common release papers and is not limited. Non-limiting examples of the release liner include bases having a release coat layer; low-adhesive bases made from fluorocarbon polymers; and low-adhesive bases made from nonpolar polymers. Non-limiting examples of the bases having a release coat layer include plastic films and papers which have been surface-treated with a release agent such as a silicone-, long-chain alkyl-, fluorine-, or molybdenum sulfide-release agent. Non-limiting examples of the fluorocarbon polymers to form the low-adhesive bases include polytetrafluoroethylenes, polychlorotrifluoroethylenes, poly(vinyl fluoride)s, poly(vinylidene fluoride)s, tetrafluoroethylene-hexafluoropropylene copolymers, and chlorofluoroethylene-vinylidene fluoride copolymers. Non-limiting examples of the nonpolar polymers to constitute the low-adhesive bases include olefinic resins such as polyethylenes and polypropylenes. The release liner can form by a known or common technique. The release liner may have any thickness. In the description, the release liner is not included in the pressure-sensitive adhesive sheet.

The pressure-sensitive adhesive sheet is used for securing an internal component of a portable electronic device. Non-limiting examples of the portable electronic device include cellular phones (mobile phones); smartphones; tablet personal computers; laptop personal computers; wearable appliances including wrist-wearable appliances which are worn like wrist watches, modular appliances which are worn on part of the body typically with a clip or strap, eye-wearable appliances including spectacle appliances (such as monocular, binocular, or head-mounted appliances), clothes-wearable appliances which are attached to, for example, shirts, socks, or hats typically as accessories, and ear-wearable appliances which are attached to an ear like an earphone; digital cameras; digital video cameras; audio equipment such as portable music players and digital voice recorders; calculating machines such as electronic calculators; handheld game consoles; electronic dictionaries; electronic organizers; digital books; on-vehicle information devices; portable radios; portable televisions; portable printers; portable scanners; and portable modems. As used herein, the term “portable” (handheld, mobile) means that the device in question is insufficient when having such portability as to be merely portable, but has to have such portability as to be relatively easily portable or mobile by an individual (standard adult). The pressure-sensitive adhesive sheet is used so that the pressure-sensitive adhesive layer adheres to the internal component of the portable electronic device. The internal component is a component that is not exposed outside in the usage mode of the portable electronic device.

In particular, the adhesive face of the pressure-sensitive adhesive sheet is preferably laminated onto a metallic part (e.g., a part made of a stainless steel such as special-use stainless steel (SUS), aluminum, or copper) in the portable electronic device. The metallic part is preferably one used for light shielding. When the pressure-sensitive adhesive sheet is a double-sided pressure-sensitive adhesive sheet, it is acceptable that one adhesive face of the pressure-sensitive adhesive sheet is laminated onto a metallic part in the portable electronic device, and the other adhesive face is laminated typically onto a graphite slab. The configuration in which the other adhesive face is laminated onto such a graphite slab enables efficient discharge of heat generated in the portable electronic device to the exterior of the device.

### EXAMPLES

The present invention will be illustrated in further detail with reference to several examples below. It should be noted, however, that these examples are never construed to limit the scope of the invention.

### Example 1

Into a reactor equipped with a stirrer, a thermometer, a nitrogen gas inlet tube, a reflux condenser, and a dropping funnel, were charged monomer components including 95 parts by mass of butyl acrylate (BA) and 5 parts by mass of acrylic acid (AA), and 233 parts by mass of ethyl acetate polymerization solvent, followed by stirring for 2 hours with introduction of nitrogen gas. After removing oxygen from the polymerization system by the above procedure, the mixture mixed with 0.2 part by mass of 2,2′-azobisisobutyronitrile polymerization initiator, followed by solution polymerization at 60° C. for 8 hours. This gave a solution of an acrylic polymer (acrylic polymer solution). The acrylic polymer had a weight-average molecular weight Mw of about 70×10⁴.

The acrylic polymer solution mixed with, per 100 parts by mass of the acrylic polymer in the solution, 0.8 part by mass of 1,2,3-benzotriazole (trade name BT-120, supplied by Johoku Chemical Co., Ltd.), 20 parts by mass of a terpene phenol resin (trade name YS POLYSTER S-145, having a softening point of about 145° C. and a hydroxyl value of 70 to 110 mg KOH/g, supplied by Yasuhara Chemical Co., Ltd.) as a tackifier resin, and crosslinkers including 2 parts by mass of an isocyanate crosslinker (trade name CORONATE L, a 75% solution of trimethylolpropane/tolylene diisocyanate trimer adduct in ethyl acetate, supplied by TOSOH CORPORATION) and 0.01 part by mass of an epoxy crosslinker (trade name TETRAD-C, 1,3-bis(N,N-diglycidylaminomethyl)cyclohexane, supplied by MITSUBISHI GAS CHEMICAL COMPANY, INC.). The resulting mixture combined with stirring and formed a pressure-sensitive adhesive composition.

The pressure-sensitive adhesive composition was applied to a release surface of a 38-μm thick polyester release liner (trade name DIAFOIL MRF, supplied by Mitsubishi Chemical Corporation), dried at 100° C. for 2 minutes, and formed a 15-μm thick pressure-sensitive adhesive layer.

Next, the exposed surface of the above-prepared pressure-sensitive adhesive layer lay on a copper foil (35-μm thick) as a substrate at room temperature using a laminator. The procedure gave a pressure-sensitive adhesive sheet of Example 1.

### Example 2

A pressure-sensitive adhesive sheet of Example 2 was prepared by a procedure similar to that in Example 1, except for forming the pressure-sensitive adhesive layer to have a thickness of 5 μm, and using, as the substrate, a copper sheet (50-μm thick).

### Example 3

A pressure-sensitive adhesive sheet of Example 3 was prepared by a procedure similar to that in Example 1, except for forming the pressure-sensitive adhesive layer to have a thickness of 4 μm, and using, as the substrate, an aluminum foil (12-μm thick).

### Example 4

A pressure-sensitive adhesive sheet of Example 4 was prepared by a procedure similar to that in Example 1, except for using, as the substrate, a silver foil (35-μm thick).

### Example 5

A pressure-sensitive adhesive sheet of Example 5 was prepared by a procedure similar to that in Example 1, except for forming the pressure-sensitive adhesive layer to have a thickness of 5 μm, and using, as the substrate, an iron sheet (50-μm thick).

### Example 6

Into a reactor equipped with a stirrer, a thermometer, a nitrogen gas inlet tube, a reflux condenser, and a dropping funnel, were charged monomer components including 30 parts by mass of 2-ethylhexyl acrylate (2EHA), 70 parts by mass of ethyl acrylate (EA), 5 parts by mass of methyl methacrylate (MMA), and 4 parts by mass of 2-hydroxyethyl acrylate (EHA); and 233 parts by mass of ethyl acetate polymerization solvent, followed by stirring for 2 hours with the introduction of nitrogen gas. After removing oxygen from the polymerization system by the procedure as above, the mixture mixed with 0.2 part by mass of 2,2′-azobisisobutyronitrile as a polymerization initiator, followed by solution polymerization at 60° C. for 8 hours. This gave an acrylic polymer solution. The acrylic polymer had a weight-average molecular weight Mw of about 90×10⁴.

The acrylic polymer solution mixed with, per 100 parts by mass of the acrylic polymer in the solution, a crosslinker of 8.5 parts by mass of an isocyanate crosslinker (trade name CORONATE L, supplied by TOSOH CORPORATION). The resulting mixture combined with stirring and formed a pressure-sensitive adhesive composition.

The pressure-sensitive adhesive composition was applied to a release surface of a 38-μm thick polyester release liner (trade name DIAFOIL MRF, supplied by Mitsubishi Chemical Corporation), dried at 100° C. for 2 minutes, and formed a 15-μm thick pressure-sensitive adhesive layer.

Next, the exposed surface of the above-prepared pressure-sensitive adhesive layer lay on a copper foil (35-μm thick) as a substrate at room temperature using a laminator. The above procedure gave a pressure-sensitive adhesive sheet of Example 6.

### Example 7

A pressure-sensitive adhesive sheet of Example 7 was prepared by a procedure similar to that in Example 1, except for preparing a pressure-sensitive adhesive composition without the incorporation of 1,2,3-benzotriazole (trade name BT-120, supplied by Johoku Chemical Co., Ltd.).

### Example 8

A monomer mixture including 66 parts by mass of 2EHA, 15 parts by mass of N-vinyl-2-pyrrolidone (NVP), and 18 parts by mass of HEA mixed with 0.07 part by mass of a photoinitiator (a 1:1 (by mass) mixture of the trade name Irgacure 184 and the trade name Irgacure 651 each supplied by BASF SE). The resulting mixture received ultraviolet radiation irradiation to a viscosity of about 20 Pa·s, and yielded a prepolymer composition in which a portion of the monomer components was polymerized. Next, 100 parts by mass of the prepolymer composition combined and mixed with 20 parts by mass of a terpene phenol resin (trade name YS POLYSTER S-145, supplied by Yasuhara Chemical Co., Ltd.) as a tackifier resin, 18 parts by mass of a low polymer between dicyclopentanyl methacrylate (DCPMA) and methyl methacrylate (MMA) (copolymerization formulation: DCPMA:MMA=60:40), 0.01 part by mass of an epoxy crosslinker (trade name TETRAD-C, supplied by MITSUBISHI GAS CHEMICAL COMPANY, INC.), 0.25 part by mass of hexanediol diacrylate (HDDA), 0.3 part by mass of a silane coupling agent (trade name KBM-403, supplied by Shin-Etsu Chemical Co., Ltd.), and 0.2 part by mass of 1,2,3-benzotriazole (trade name BT-120, supplied by Johoku Chemical Co., Ltd.), and yielded a pressure-sensitive adhesive composition (uncured composition).

The pressure-sensitive adhesive composition was applied to a poly(ethylene terephthalate) (PET) release liner (trade name MRF 50, supplied by Mitsubishi Chemical Corporation) so as to have a final thickness (thickness of the pressure-sensitive adhesive layer) of 15 μm, the coat layer was covered with a PET release liner (trade name MRF 38, supplied by Mitsubishi Chemical Corporation) for exclusion of oxygen, and was irradiated with ultraviolet radiation at an illuminance of 5 mW/cm² for 300 seconds to be cured. This gave a 15-μm thick pressure-sensitive adhesive layer whose both surfaces were protected by the release liners.

Next, one of the release liners was removed to expose an adhesive face of the pressure-sensitive adhesive layer. The exposed surface of the resulting pressure-sensitive adhesive layer lay on a copper foil (35-μm thick) as a substrate at room temperature using a laminator. The above procedure gave a pressure-sensitive adhesive sheet of Example 8.

### Comparative Example 1

A pressure-sensitive adhesive sheet of Comparative Example 1 was prepared by a procedure similar to that in Example 1, except for using, as the substrate, a graphite slab (30-μm thick).

### Comparative Example 2

A pressure-sensitive adhesive sheet of Comparative Example 2 was prepared by a procedure similar to that in Example 1, except for forming the pressure-sensitive adhesive layer to have a thickness of 10 μm, and using, as the substrate, an aluminum foil (5-μm thick).

### Comparative Example 3

A pressure-sensitive adhesive sheet of Comparative Example 3 was prepared by a procedure similar to that in Example 1 except for forming the pressure-sensitive adhesive layer to have a thickness of 5 μm, and using, as the substrate, a PET film (50-μm thick).

Evaluations

The pressure-sensitive adhesive sheets obtained in the examples and the comparative examples were evaluated as follows. The results are presented in Table 1.

### (1) Electric Field Shielding Effect and Magnetic Field Shielding Effect

A series of evaluation samples was prepared by cutting a 150-mm square piece from each of the pressure-sensitive adhesive sheets obtained in the examples and the comparative examples. Next, each evaluation sample was held between a pair of cube type steel wool, and the resulting article was held between a receiving jig and a transmitting jig which were arranged to face each other in an electromagnetic shielding effect measuring apparatus. The receiving jig and the transmitting jig have such a structure as to be bilaterally symmetrically divided in a plane perpendicular to the transmission axial direction. In the KEC method, initially, a signal output from a spectrum analyzer travels through an attenuator and enters the transmitting jig. The signal is then received by the receiving jig, travels through the attenuator, and is amplified by a preamplifier, and the signal level of the signal is measured using a spectrum analyzer. The spectrum analyzer outputs an attenuation in the case where the evaluation sample is placed in the electromagnetic shielding effect measuring apparatus, in comparison with an attenuation in the case where the evaluation sample is not placed in the electromagnetic shielding effect measuring apparatus. Using the apparatus as above, the electric field shielding effect and magnetic field shielding effect, which are electromagnetic shielding properties, were measured at a temperature of 23° C. and at 100 kHz to 1000 kHz.

### (2) Adhesive Strength

A series of measurement samples was prepared by cutting a piece having a width of 25 mm and a length of 100 mm from each of the pressure-sensitive adhesive sheets obtained in the examples and the comparative examples. An adherend was prepared by securing a 50-μm thick PET film (trade name LUMIRROR S10, supplied by Toray Industries Inc.) to a stainless steel sheet through a double-sided pressure-sensitive adhesive tape. The adhesive face of each measurement sample was compression-bonded to a surface (surface of the PET film) of the adherend through one reciprocating movement of a 2-kg roller, in an environment at a temperature of 23° C. and relative humidity of 50%. The resulting article was left in the same environment for 30 minutes, then underwent measurement of peel strength (N/25 mm) in accordance with JIS Z 0237:2009 at a tensile speed of 300 mm/min and a peel angle of 180° using a universal tensile and compression testing machine (trade name Tensile and Compression Testing Machine TG-1kN, supplied by MinebeaMitsumi Inc.). The measured peel strength was defined as the adhesive strength of the sample.

TABLE 1

| | | Example | Example | Example | Example | Example | Example | Example | Example | Com. | Com. | Com. |
|---|---|---|---|---|---|---|---|---|---|---|---|---|
| | | 1 | 2 | 3 | 4 | 5 | 6 | 7 | 8 | Ex. 1 | Ex. 2 | Ex. 3 |
| Monomer | BA | 95 | 95 | 95 | 95 | 95 | — | 95 | — | 95 | 95 | 95 |
| component | AA | 5 | 5 | 5 | 5 | 5 | — | 5 | — | 5 | 5 | 5 |
| (part by | 2EHA | — | — | — | — | — | 30 | — | 66 | — | — | — |
| mass) | EA | — | — | — | — | — | 70 | — | — | — | — | — |
| | NVP | — | — | — | — | — | — | — | 15 | — | — | — |
| | MMA | — | — | — | — | — | 5 | — | — | — | — | — |
| | HEA | — | — | — | — | — | 4 | — | 18 | — | — | — |
| Tackifier | S-145 | 20 | 20 | 20 | 20 | 20 | — | 20 | 20 | 20 | 20 | 20 |
| resin | DCPMA/ | — | — | — | — | — | — | — | 18 | — | — | — |
| (part by | MMA | | | | | | | | | | | |
| mass) | copolymer | | | | | | | | | | | |
| Rust | Benzotriazole | 0.8 | 0.8 | 0.8 | 0.8 | 0.8 | — | — | 0.2 | 0.8 | 0.8 | 0.8 |
| inhibitor | | | | | | | | | | | | |
| (part by | | | | | | | | | | | | |
| mass) | | | | | | | | | | | | |
| Crosslinker | CORONATE L | 2 | 2 | 2 | 2 | 2 | 8.5 | 2 | — | 2 | 2 | 2 |
| (part by | TETRAD-C | 0.01 | 0.01 | 0.01 | 0.01 | 0.01 | — | 0.01 | 0.01 | 0.01 | 0.01 | 0.01 |
| mass) | HDDA | — | — | — | — | — | — | — | 0.25 | — | — | — |
| | KBM-403 | — | — | — | — | — | — | — | 0.3 | — | — | — |
| Substrate layer | | Cu | Cu | Al | Ag | Fe | Cu | Cu | Cu | graphite | Al | PET |
| Substrate layer | | 35 | 50 | 12 | 35 | 50 | 35 | 35 | 35 | 30 | 5 | 50 |
| thickness (μm) | | | | | | | | | | | | |
| Pressure-sensitive | | 15 | 5 | 4 | 15 | 5 | 15 | 15 | 15 | 15 | 10 | 5 |
| adhesive layer | | | | | | | | | | | | |
| thickness (μm) | | | | | | | | | | | | |
| Pressure-sensitive | | 50 | 55 | 16 | 50 | 55 | 50 | 50 | 50 | 45 | 15 | 55 |
| adhesive sheet | | | | | | | | | | | | |
| thickness (μm) | | | | | | | | | | | | |
| Thickness ratio of | | 0.43 | 0.10 | 0.33 | 0.43 | 0.10 | 0.43 | 0.43 | 0.43 | 0.50 | 2.00 | 0.10 |
| pressure-sensitive | | | | | | | | | | | | |
| adhesive layer to | | | | | | | | | | | | |
| substrate layer | | | | | | | | | | | | |
| Electric | 100 kHz | 25 | 25 | 25 | 25 | 25 | 25 | 25 | 25 | 25 | 25 | 0.1 |
| field | 1000 kHz | 53 | 53 | 53 | 53 | 53 | 53 | 53 | 53 | 53 | 53 | 0.1 |
| shielding | | | | | | | | | | | | |
| effect (dB) | | | | | | | | | | | | |
| Magnetic | 100 kHz | 9.1 | 11 | 5.2 | 10.2 | 5.8 | 9.1 | 9.1 | 9.1 | 0.1 | 2 | 0.2 |
| field | 1000 kHz | 34.7 | 38.4 | 23.0 | 36.3 | 24.4 | 34.7 | 34.7 | 34.7 | 4.9 | 10.4 | 1.4 |
| shielding | | | | | | | | | | | | |
| effect (dB) | | | | | | | | | | | | |

| | | | | | | | | | | | |
|---|---|---|---|---|---|---|---|---|---|---|---|
| Adhesive strength | 26 | 20 | 13 | 22 | 22 | 5 | 26 | 8 | 18 | 10 | 16 |
| (N/25 mm) | | | | | | | | | | | |

### (3) Corrosion Resistance

Corrosion Protection Test

A series of laminate samples was prepared by lining the adhesive face of each of the pressure-sensitive adhesive sheets obtained in the examples with a 200-μm transparent PET film, and cutting the resulting article to a 10-mm square piece. Each laminate sample had a structure including the PET film, the pressure-sensitive adhesive layer, and the substrate layer disposed in the specified sequence. Each sample was stored under hot and humid conditions at a temperature of 85° C. and relative humidity of 85%. Five hundred (500) hours into the storage, the substrate layer was visually observed through the PET film, and the sample were evaluated for corrosion protection (corrosion resistance) by change in appearance. As a result, the samples according to Examples 1 to 6, and 8 did not show change in color in the observation after 500-hour storage and were evaluated as having excellent corrosion protection performance.

### REFERENCE SIGNS LIST

1 pressure-sensitive adhesive sheet
11 substrate layer
12 pressure-sensitive adhesive layer

1. A pressure-sensitive adhesive sheet comprising:
a substrate layer; and
a pressure-sensitive adhesive layer disposed on or over at least one side of the substrate layer,
the substrate layer including a metal layer having a thickness of 10 to 80 μm,
the pressure-sensitive adhesive sheet having a total thickness of 100 μm or less,
the pressure-sensitive adhesive sheet having an electric field shielding effect of 20 dB or more as measured by a KEC method at a frequency of 100 kHz to 1000 kHz,
the pressure-sensitive adhesive sheet having a magnetic field shielding effect of 5 dB or more as measured by the KEC method at a frequency of 100 kHz to 1000 kHz, and
the pressure-sensitive adhesive sheet being used for securing an internal component of a portable electronic device.

2. The pressure-sensitive adhesive sheet according to claim 1,
wherein the pressure-sensitive adhesive layer includes:
an acrylic polymer as a base polymer; and
a tackifier resin.

3. The pressure-sensitive adhesive sheet according to claim 2,
wherein the acrylic polymer includes at least one of:
a constitutional unit derived from a carboxy-containing monomer; and
a constitutional unit derived from an acid anhydride monomer.

4. The pressure-sensitive adhesive sheet according to claim 2,
wherein the pressure-sensitive adhesive layer further includes an azole rust inhibitor, and
wherein the azole rust inhibitor is present in a proportion of less than 8 parts by mass per 100 parts by mass of the totality of the base polymer.

5. The pressure-sensitive adhesive sheet according to claim 4,
wherein the azole rust inhibitor includes at least one benzotriazole compound selected from the group consisting of:
1,2,3-benzotriazole;
5-methylbenzotriazole;
4-methylbenzotriazole; and
carboxybenzotriazole.

6. The pressure-sensitive adhesive sheet according to claim 1,
wherein the pressure-sensitive adhesive sheet has a thickness ratio of the pressure-sensitive adhesive layer to the substrate layer of 0.05 to 1.0.

7. The pressure-sensitive adhesive sheet according to claim 1,
wherein the internal component is a metallic part inside the portable electronic device, and
wherein the pressure-sensitive adhesive layer is to adhere to the metallic part.

8. The pressure-sensitive adhesive sheet according to claim 1,
wherein a metal constituting the metal layer has a resistivity of 4.0×10⁻⁸ Ω·m or less.

9. The pressure-sensitive adhesive sheet according to claim 1,
wherein a metal constituting the metal layer has an electric conductivity of 40% or more.

10. The pressure-sensitive adhesive sheet according to claim 1,
wherein a metal constituting the metal layer has a permeability of 1 or more, provided that copper has a permeability of 1.

11. The pressure-sensitive adhesive sheet according to claim 1,
wherein the metal layer includes at least one of:
a copper layer;
a silver layer;
an aluminum layer; and
an iron layer.

12. The pressure-sensitive adhesive sheet according to claim 1,
wherein the metal layer is a copper layer or a silver layer and has a thickness of 30 to 60 μm.

13. The pressure-sensitive adhesive sheet according to claim 1,
wherein the metal layer is an aluminum layer and has a thickness of 10 to 30 μm.

14. The pressure-sensitive adhesive sheet according to claim 1,
wherein the metal layer is an iron layer and has a thickness of 40 to 70 μm.

15. The pressure-sensitive adhesive sheet according to claim 1,
wherein a surface of the pressure-sensitive adhesive layer has an adhesive strength to a poly(ethylene terephthalate) film of 5 N/25 mm or more, as measured at a temperature of 23° C., a peel angle of 180°, and a peel rate of 300 mm/min.

16. The pressure-sensitive adhesive sheet according to claim 1,
wherein the pressure-sensitive adhesive sheet has a discoloration time of 200 hours or longer, where the discoloration time is a time by which a change in color of the metal layer is visually observed at a temperature of 65° C. and relative humidity of 90%.

17. The pressure-sensitive adhesive sheet according to claim 1,
wherein the pressure-sensitive adhesive layer contains approximately no conductive particle.

18. The pressure-sensitive adhesive sheet according to claim 1, further comprising
a black layer disposed on at least one side of the substrate layer.

19. The pressure-sensitive adhesive sheet according to claim 18,
wherein the black layer is disposed on, of two surfaces of the substrate layer, a surface facing toward the outer side of the portable electronic device.
